(19) United States
(12) Patent Application Publication
(10) Pub. No.: US 2008/0021759 A1
(43) Pub. Date: Jan. 24, 2008

(54) Method and system for managing an action

(76) Inventor: William Mervyn Wasley, Halls Head (AU)

Correspondence Address: EDELL, SHAPIRO & FINNAN, LLC, 1901 RESEARCH BOULEVARD, SUITE 400, ROCKVILLE, MD, 20850, US

(21) Appl. No.: 11/488,920

(22) Filed: Jul. 19, 2006

(51) Int. Cl. G06Q 10/00

(52) U.S. Cl. 705/9; 705/11

(57) ABSTRACT

A method of managing an action within an organization is provided, where the organization includes at least two positions, each position includes one or more occupants, each occupant is an individual for performing an action. The method includes, in a processing system: for an action associated with a first position, comparing an action status to management criteria; and, alerting a second position depending on a result of the comparison.

### TECHNICAL FIELD

The present invention generally relates to a method and apparatus for managing actions within an organization, and more particularly to a method and apparatus for managing actions by generating alerts dependent on an action status.

### BACKGROUND ART

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The fall of Enron and other miss-management issues in publicly listed companies spurred the United States Government to introduce the Sarbanes-Oxley (SOX) Act, in 2002.

Accordingly, corporations must comply with the financial reporting and auditing standards as required by the Act.

However, many corporations find it difficult to comply with the strict standards of reporting as required by the Act. In particular, compliance with the Act often adds significant overhead to the management of particular actions within an organization.

The tough standards introduced by the Sarbanes-Oxley Act require that management is constantly aware of the tasks being completed at each level of the organizational hierarchy.

Without strict policies within organizations to control and manage actions, an organization could be subject to potentially fatal consequences, where miss-management could lead to the collapse of the organization.

Presently, there is no system that allows for the monitoring of actions, where management is automatically alerted, if a particular action has not met management criteria (for example, if the action has missed a deadline, or is incomplete).

### DISCLOSURE OF INVENTION

In a first broad form the present invention provides a method of managing an action within an organization, the organization including at least two positions, each position having one or more occupants, each occupant being an individual for performing an action, the method including, in a processing system:
a) for an action associated with a first position, comparing an action status to management criteria; and,
b) alerting a second position depending on a result of the comparison.

Typically the positions within the organization are arranged in a hierarchy with the second position being more senior than the first position.

The method generally includes, in the processing system:
a) for a selected position more senior than the first position, determining if the selected position is occupied; and,
b) determining the selected position to be the second position if the selected position is occupied.

Typically the method includes, in the processing system, escalating the action to the second position such that the action can be performed by an occupant of the second position.

The method may include, in the processing system, escalating the action by adding the action to an action indication associated with the second position.

The method typically includes, in the processing system, repeatedly escalating the action through the organization until a predetermined action status is reached.

The method optionally includes, in the processing system, comparing the action status to the management criteria to determine if the action is at least one of:
a) started;
b) partially completed; and,
c) completed.

Each action is generally formed from a sequence of one or more tasks, and wherein the method includes, in the processing system, determining an action status by monitoring for the completion of the one or more tasks associated with the action.

Typically the method includes, in the processing system, comparing the action status to the management criteria by:
a) determining at least one time frame from the at least one management criterion, the at least one time frame being indicative of a time for completion of a corresponding task; and,
b) determining if the corresponding task is completed within the at least one time frame.

The processing system typically communicates the alert by at least one of:
a) email; and,
b) a message on a management console.

The method typically includes, in the processing system, storing action data indicative of performed actions.

The action data may be indicative of at least one of:
a) positions to which actions have been assigned;
b) positions to which actions have been escalated;
c) an indication of monitored action status and whether action milestones are met; and,
d) details of any generated alerts.

The method generally includes, in the processing system, implementing a reporting module, the reporting module being for:
a) retrieving action data; and,
b) generating a report based on the action data.

Typically the method includes, in the processing system, implementing an action management module, the action management module being for:
a) comparing the action status to the management criteria; and,
b) generating an alert depending on a result of the comparison.

The action management module may be for:
a) receiving at least one action from at least one other module; and,
b) managing the at least one action.

The method can include, in the processing system, interacting with position tree data representing a position tree indicative of the structure of positions within the organization, the interaction including at least one of generating, storing, and accessing the position tree data.

The position tree data is generally indicative of:
a) positions within the organization; and,
b) relationships between the positions.

The position tree data may be indicative of:
a) individuals occupying positions within the organization
b) roles associated with respective positions; and,
c) actions associated with the positions.

The processing system typically implements a position tree module for:
a) interacting with the position tree data; and
b) providing details of the position tree to one or more other modules.

In a second broad form the present invention provides apparatus for managing an action within an organization, the organization including at least two positions, each position having one or more occupants, each occupant being an individual for performing an action, the apparatus including a processing system for:
a) for an action associated with a first position comparing an action status to management criteria;
b) alerting a second position depending on a result of the comparison.

The apparatus may be used for performing the method of the first broad form of the invention.

In a third broad form the present invention provides a computer program product for managing an action within an organization, the computer program product including computer executable code which when implemented by a suitable processing system causes the processing system to:
a) for an action associated with a first position compare an action status to management criteria;
b) alert a second position depending on a result of the comparison.

The computer program product may be used for performing the method of the first broad form of the invention.

In a forth broad form the present invention provides a computer implemented method for action management within an organizational structure comprising:
creating a position definition;
associating one or more occupants to the position;
linking the position definition to a parent position definition;
assigning an action to the position definition; and
defining action execution parameters for the action
wherein, if the action satisfies a predetermined criterion based on one or more execution parameters then, one or more occupants of an ancestor position are alerted.

Typically one or more occupants of the parent position are alerted.

If the parent position does not have at least one occupant, one or more occupants of a grandparent position superior the parent position are generally alerted.

Each ancestor position of the position may be recursively examined until an occupied ancestor position is located that has at least one occupant and the one or more occupants of the occupied ancestor position are alerted.

The alert may be communicated in the form of an email, or in the form of a message on a management console.

The execution parameters typically include a due date for completion of the action.

The predetermined criterion may be that the date for completion has passed without completion of the action.

The execution parameters typically include a date for starting the action and the predetermined criterion is that the date for starting the action has passed without the action being started.

Alternatively or additionally, the execution parameters may a percent complete milestone date for having a fixed percentage of the action complete and a percentage complete parameter to indicate the percentage of the action complete and the predetermined criterion is the date for starting the action has passed and that the has-started flag indicates that the action has not yet been started.

### BRIEF DESCRIPTION OF FIGURES

Examples of the present invention should become apparent from the following description, which is given by way of example only, of a preferred but non-limiting embodiment, described in connection with the accompanying figures.

FIG. 1 illustrates an example flow diagram of a method/process that can be utilised to embody or give effect to a particular embodiment;

FIG. 2 illustrates an example functional block diagram of a processing system that can be utilised to embody or give effect to a particular embodiment;

FIG. 3 illustrates an example network infrastructure that can be utilised to embody or give effect to a particular embodiment;

FIG. 4A illustrates another example flow diagram of a method/process that can be utilised to embody or give effect to a particular embodiment;

FIG. 4B illustrates another example flow diagram that is a continuation of the diagram of FIG. 4A;

FIG. 5 illustrates an example of a position tree representing an organizational structure;

FIG. 6 illustrates an example graphical user interface used for viewing an manipulating a position tree;

FIG. 7 illustrates an example graphical user interface showing an example of options associated with a position tree;

FIG. 8 illustrates an example graphical user interface for editing details of a position within an organizational structure;

FIG. 9 illustrates an example of a database structure for use in action management.

FIG. 10 illustrates an example graphical user interface showing actions and completion statistics for a position;

FIG. 11 illustrates an example of a graphical user interface for incident searching;

FIG. 12 illustrates an example of an architecture for action management;

FIG. 13 illustrates an example of a graphical user interface for document searching;

FIG. 14 illustrates an example of a graphical user interface for a calendar application; and,

FIG. 15 illustrates an example deployment of a system for managing actions.

### MODES FOR CARRYING OUT THE INVENTION

In the figures, incorporated to illustrate features of examples, like reference numerals are used to identify like parts throughout the figures.

An example of a process of managing an action within an organization will now be described. For the purpose of this example, the organization includes at least two positions, each position having one or more occupants for performing actions. In this example, the method includes, in a processing system, and for an action associated with a first position, comparing an action status to management criteria and alerting a second position depending on a result of the comparison.

The organization may be a company, business, corporation or other similar entity, which has individuals capable of performing tasks. The individuals occupy positions within the organization so that when an action is assigned to a position, this action may be performed by one or more of the individuals occupying the position. Occupants of positions may be assigned different roles within the organization, and it will therefore be appreciated that the position may correspond to a respective job type, title or level within the organization, such as a manager, senior manager, or the like. The actions may include one or more tasks, and these can be performed by different ones of the position occupants, as will be described in more detail below.

By having actions associated with positions as opposed to individuals within an organization, this helps ensure that actions are performed even if an individual moves position, or leaves the organization. This can be achieved by simply having another individual assigned to the position, or escalating the action to another occupied position. Similarly, by providing alerts to positions, this ensures that alert, is received and appropriate measures taken to ensure the action is completed. Even once actions have been completed or alerts have been actioned, a record can be maintained associated with the position. This also ensures that if an individual leaves an organization, and data associated with that individual is deleted or becomes misplaced, a record of the action completion and any generated alerts are not also lost.

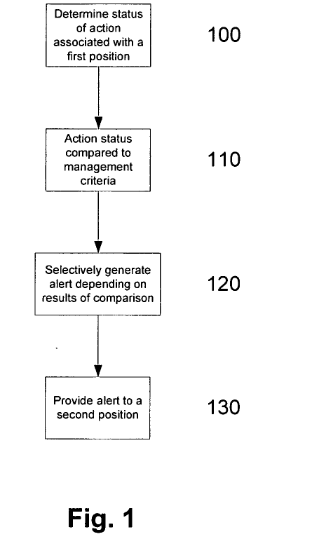

An example of the process is shown in more detail in FIG. 1. In this example, the method includes, at step 100 determining a status of an action associated with a first position, at step 110 comparing the action status with management criteria, at step 120 selectively generating an alert depending on the results of the comparison, and at step 130 alerting a second position.

As mentioned above, actions are assigned to positions within the organization as opposed to individual people, allowing for tighter management control over actions so that actions do not get “lost” or need re-assignment if an occupant of a position changes, or an individual leaves the organization.

Furthermore, the positions are typically arranged in a hierarchy, so that the second position is a more senior or superior position than the first position. This allows alerts to be provided to more senior positions in the event that the actions are not completed in accordance with the management criteria thereby helping to ensure that the Sarbanes-Oxley requirements are met.

Thus, for example, if a manager fails to complete an action in a due time, a senior manager can be alerted, thereby ensuring the action is ultimately performed.

The management criteria can include due dates associated with the action, so that when the comparison is performed, it can be judged whether the action has not been completed in due time, has not been started by a planned start date, or has only been partially completed in accordance with particular milestones, or the like. In this regard, the term due date corresponds to any time limit for performing an action and may include a time period, date, time, or the like.

In one example, each action is formed from a sequence of one or more tasks, so that the action status can be determined by monitoring for the completion of the tasks. Hence, the comparison can involve determining if each task is completed within the time frames indicated within the management criteria.

In one example, the process of alerting the second position includes determining if the second position is occupied, and if the second position is not occupied, choosing another occupied second position, or another more senior position.

Thus, for example, if a particular action has not been completed by a certain date by the first position, a supervisor of the first position is alerted. If the supervisor is away, or if the supervisor has left the organization, then the managing supervisor or the general manager is alerted. This helps ensure that an individual ultimately becomes informed of the failure to complete the action, even though the alerts are provided based on the position structure.

Once the second position has been alerted, the action can then be assigned to the second position, or alternatively the second position can then assign the action to another position within the organization to ensure that the action is performed in accordance with the particular management criteria. The process of assigning the action to a more senior position is referred to as escalation, and in one example, the action is escalated through the organization until it is completed, or the associated management criteria are satisfied.

Escalating an action typically includes adding the action to an action indication, such as a list of due actions, associated with the second position, to thereby allow occupants of the second position to review and then perform pending actions. The action status can then be periodically compared to the management criteria, with the action being repeatedly escalated through the organization as required, until the management criteria are satisfied and a predetermined action status reached.

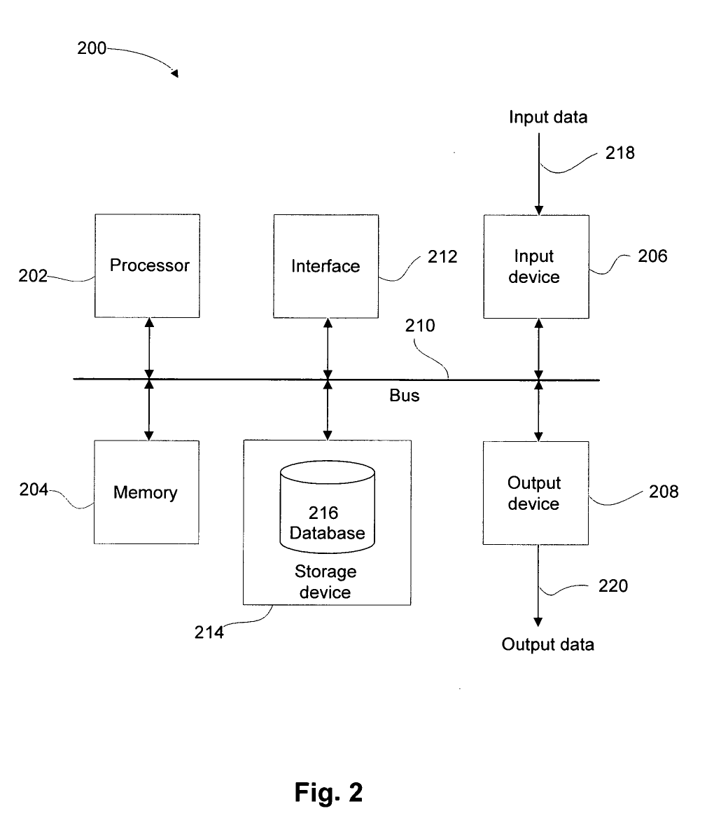

Typically, the above-described method can be realised using a processing system, such that, for example, the alert can be communicated by email or a message on a management console. An example processing system is shown in FIG. 2. In particular, the processing system 200 generally includes at least one processor 202, or processing unit or plurality of processors, memory 204, at least one input device 206 and at least one output device 208, coupled together via a bus or group of buses 210. In certain embodiments, input device 206 and output device 208 could be the same device. An interface 212 can also be provided for coupling the processing system 200 to one or more peripheral devices, for example interface 212 could be a PCI card or PC card. At least one storage device 214 which houses at least one database 216 can also be provided. The memory 204 can be any form of memory device, for example, volatile or non-volatile memory, solid state storage devices, magnetic devices, etc.

The processor 202 could include more than one distinct processing device, for example to handle different functions within the processing system 200. Input device 206 receives input data 218 and can include, for example, a keyboard, a pointer device such as a pen-like device or a mouse, audio receiving device for voice controlled activation such as a microphone, data receiver or antenna such as a modem or wireless data adaptor, data acquisition card, etc.

Input data 218 could come from different sources, for example keyboard instructions in conjunction with data received via a network. Output device 208 produces or generates output data 220 and can include, for example, a display device or monitor in which case output data 220 is visual, a printer in which case output data 220 is printed, a port for example a USB port, a peripheral component adaptor, a data transmitter or antenna such as a modem or wireless network adaptor, etc.

Output data 220 could be distinct and derived from different output devices, for example a visual display on a monitor in conjunction with data transmitted to a network. A user could view data output, or an interpretation of the data output, on, for example, a monitor or using a printer. The storage device 214 can be any form of data or information storage means, for example, volatile or non-volatile memory, solid state storage devices, magnetic devices, etc.

In use, the processing system 200 is adapted to allow data or information to be stored in and/or retrieved from, via wired or wireless communication means, the at least one database 216. The interface 212 may allow wired and/or wireless communication between the processing unit 202 and peripheral components that may serve a specialised purpose. The processor 202 receives instructions as input data 218 via input device 206 and can display processed results or other output to a user by utilising output device 208. More than one input device 206 and/or output device 208 can be provided. It should be appreciated that the processing system 200 may be any form of terminal, server, specialised hardware, or the like.

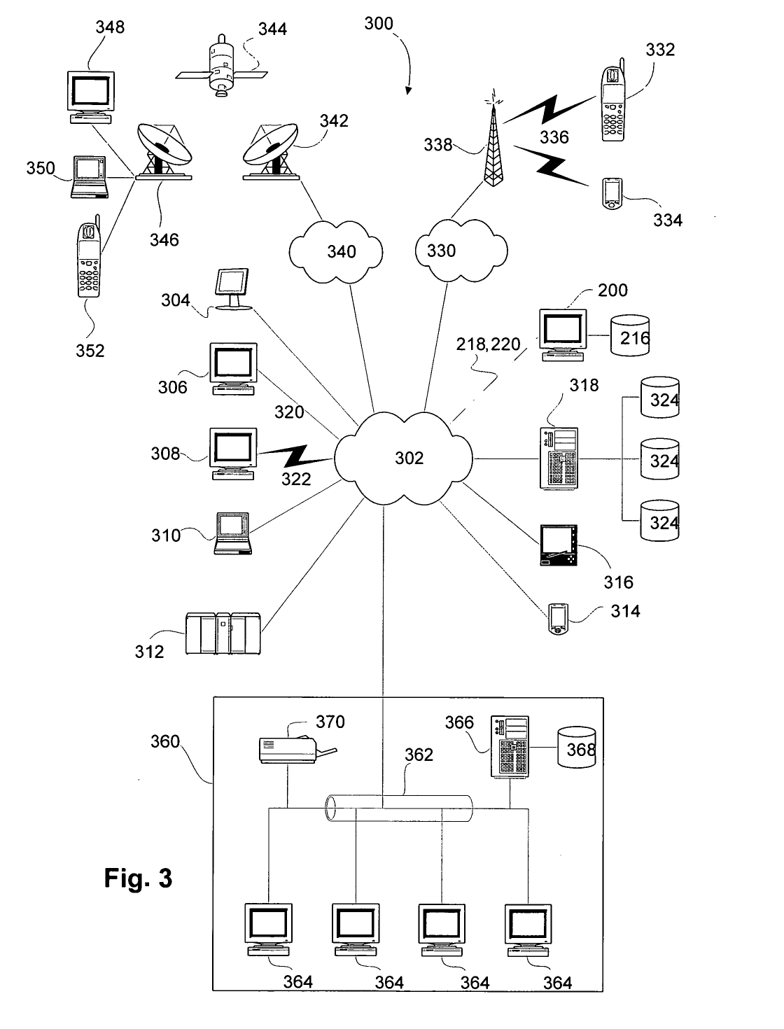

The processing system 200 may be a part of a networked communications system 300, as shown in FIG. 3. Processing system 200 could connect to network 302, for example the Internet, WAN, or a LAN. Input data 218 and output data 220 could be communicated to other devices via network 302. Other terminals, for example, thin client 304, end stations 306 and 308, notebook computer 310, mainframe computer 312, PDA 314, pen-based computer 316, server 318, etc., can be connected to network 302. A large variety of other types of terminals or configurations could be utilised. The transfer of information and/or data over network 302 can be achieved using wired communications means 320 or wireless communications means 322. Server 318 can facilitate the transfer of data between network 302 and one or more databases 324. Server 318 and one or more databases 324 provide an example of an information source.

Other networks may communicate with network 302. For example, telecommunications network 330 could facilitate the transfer of data between network 302 and mobile or cellular telephone 332 or a PDA-type device 334, by utilising wireless communication means 336 and receiving/transmitting station 338. Satellite communications network 340 could communicate with satellite signal receiver 342 which receives data signals from satellite 344 which in turn is in remote communication with satellite signal transmitter 346. Terminals, for example further end stations 348, notebook computer 350 or satellite telephone 352, can thereby communicate with network 302. A local network 360, which for example may be a private network, LAN, etc., may also be connected to network 302. For example, network 302 could be connected with Ethernet 362 which connects terminals 364, server 366 which controls the transfer of data to and/or from database 368, and printer 370. Various other types of networks could be utilised.

The processing system 200 is adapted to communicate with other terminals, for example the end stations 306, 308, by sending and receiving data, 218, 220, to and from the network 302, thereby facilitating possible communication with other components of the networked communications system 300.

Thus, for example, the networks 302, 330, 340 may form part of, or be connected to, the Internet, in which case, the terminals 306, 312, 318, for example, may be web servers, Internet terminals or the like. The networks 302, 330, 340, 360 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

Notably, in a networked information or data communications system, a user has access to one or more terminals or end stations which are capable of requesting and/or receiving information or data from local or remote information sources. In such a communications system, a terminal or end station may be any type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid state drive.

An information source can include a server, or any type of terminal, that may be associated with one or more storage devices that are able to store information or data, for example in one or more databases residing on a storage device. The exchange of information (i.e., the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internet, Intranet, the Internet and developments thereof, transient or temporary networks, combinations of the above or any other type of network providing for communication between computerised, electronic or digital devices. More than one distinct network can be provided, for example a private and a public network. A network as referenced in this specification should be taken to include any type of terminal or other similar type of electronic device, or part thereof, which is rendered such that it is capable of communicating with at least one other terminal.

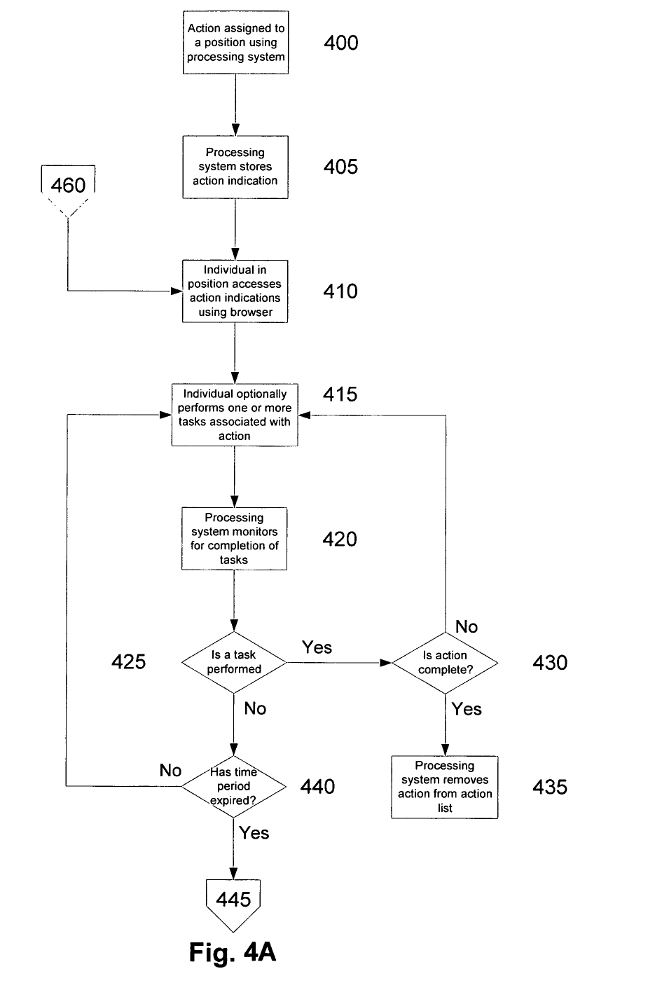

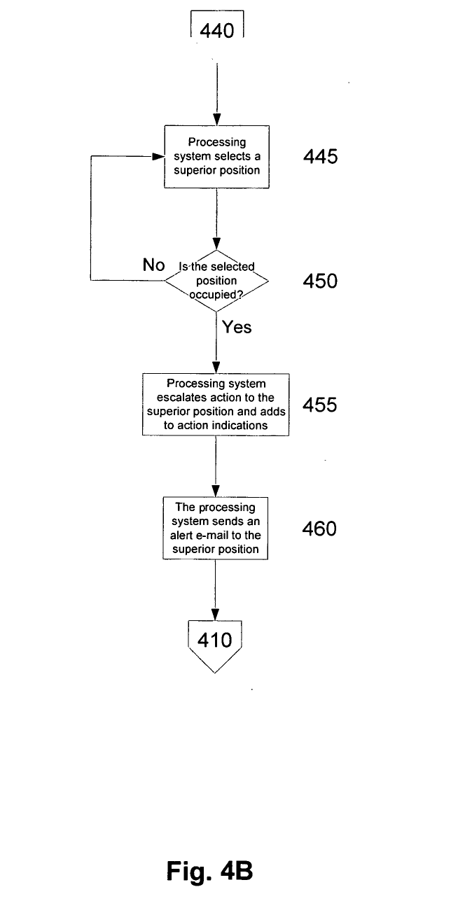

A more detailed specific example process will now be described with respect to FIGS. 4A and 4B.

In this example, at step 400 an action is assigned to a position using a processing system, such as the processing system 200. The processing system 200 stores an action indication at step 405, allowing an individual occupying the position to access the action indication using a web browser, or the like implemented by the end station 308 at step 410. This allows the individual to review pending actions assigned to their position.

At step 415 the occupant then optionally performs one or more of the tasks associated with the action. The processing system 200 can continuously or periodically monitor the completion of the tasks as shown at step 420. This may be performed in any one of a number of manners. Thus, the individual performing the action can be required to provide an indication of when tasks are completed, for example by updating the action indication using the web browser. Alternatively, this can be achieved automatically, by having the processing system 200 monitor for completion of the tasks. This may be achieved for example by having the processing system 200 execute applications software that detects events corresponding to task completion.

If it is determined that the task has been performed at step 425, then the processing system 200 determines whether the action has been completed at step 430, by comparing details of the completed tasks to the management criteria. If it is determined that the action has been completed, then the processing system 200 removes the action from the action list, at step 435. Optionally the processing system 200 provides an indication of the action completion, for example by generating an alert to a position within the organization. Otherwise, if the action has not been completed, the process returns to step 415.

At step 425, if it is determined that a task has not been completed, then the process moves on to step 440, with the processing system 200 checking to see whether a specified time period has expired (for example, a due date or the like). If the time period has not expired, then the process returns to step 415.

If the time period has expired, the processing system 200 selects a position that is superior to the original position that was responsible for completing the task, at step 445. This is typically determined from a defined organization hierarchy, which is stored in a suitable database, as will be described in more detail below. The processing system 200 then checks to see whether the selected position is occupied at step 450. If the position is not occupied, the processing system 200 checks another superior position (that is, step 445 is repeated).

Once an occupied superior position is determined, the processing system 200 escalates the action to the superior position and adds details of the action to the action indications associated with the superior position, at step 455. This will typically include details of the tasks that have so far been completed, and an indication of the individual performing the tasks, allowing the occupants of the superior position to review details of the action, and determine what further tasks require completion.

At step 460, the processing system 200 alerts the superior position as to the incomplete nature of the action, allowing an occupant of the superior position to review the action indications, and arrange for the action to be completed.

The process then returns to step 410, where the individual now responsible for completing the action is the individual associated with the chosen superior position. This ensures that the process is repeated until the action is complete.

Thus, for example, the above described process can be used in monitoring marketing tasks for an organization. A marketing manager can use the processing system 200 to assign an action, such as the preparation of an advertisement campaign, to a first position, such as a marketing coordinator. The action is added to an action indication, allowing an individual occupying the marketing coordinator position to view details of the action via a browser application executed by their computer, such as an end station 308. Management criteria are also defined and stored specifying the time limits for completing the marketing campaign.

The processing system 200 then monitors the progress of the preparation of the advertisement campaign as described above. If the preparation has been completed, then the action is noted as complete and the method terminates.

However, if the action has not been completed, then the processing system 200 determines the superior position to the marketing coordinator, which in this example is the marketing manager, and sends an alert to the marketing manager alerting the manager that the preparation for the advertisement has not been completed by the predetermined deadline.

Upon receipt of the alert, the marketing manager can then assign, instruct the processing system 200 to assign, or the processing system 200 can automatically assign the preparation of the advertising campaign to a second position. In this example, the campaign preparation is assigned to the marketing manager, with a new deadline for completion.

The processing system 200 then continually checks the progress of the action and determines whether the action has been completed. If the action has been completed then the process terminates. Otherwise, the processing system 200 can then alert a superior position to the marketing manager, such as the general manager as to the incompletion of the action, and the process continues until the action is complete or cancelled.

It will be appreciated by persons skilled in the art that the organization can be spread across numerous geographical jurisdictions, where a manager in, for example, London could assign an action to a subordinate in New York, and the monitoring of the task can be performed by a central processor in the head office of the organization, in Sydney.

### Reporting

It will also be appreciated that the process can be used to provide reporting of the above described process. In particular, results of different stages of the processes can be stored to allow an audit trail to be subsequently constructed. This can involve storing action data including information such as:
positions to which actions have been assigned
positions to which actions have been escalated
determinations as to action status and whether action milestones are met; and,
details of any generated alerts.

To ensure the audit trail of action performance is accurate, it is typical to ensure that the action data is stored in such a manner as to prevent subsequent alteration. This may include any one of a number of different protection mechanisms, such as storing the information in a separate audit trail or SOX database, encrypting the action data, providing a time stamp or the like.

Storing of the action data allows managers, independent auditors, or the like, to subsequently review the performance of actions within the organization, thereby helping to ensure Sarbanes-Oxley requirements are satisfied.

In one example, the processing system 200 can be adapted to allow the action data to be accessed using a report generation procedure. This may be achieved in any one of a number of ways, such as by having the processing system 200 implement report generation applications software.

In this example, a user of one of the end stations 308 can access a graphical user interface (GUI) generated by the processing system 200, allowing a particular report to be selected. This can include, for example, a report on details of the performance of predetermined actions, or alternatively a report on details of actions performed by certain positions within the organization. The processing system 200 will then query the action data stored in the database to allow the relevant information to be extracted, which can then be imported into a template, or the like, to generate an appropriate report document. The report can then be presented to the user via the end station 308.

### Further Examples

Aspects of a specific implementation of the process will now be described.

In this example, the above described action management and reporting procedures as a part of an integrated software application that forms an overall Administration Management System (hereinafter referred to as HAMS). In general, HAMS is a web-based application that provides a variety of Safety, HR, Risk Management and administrative functions.

Functions within HAMS are typically implemented using a number of different modules that are capable of interacting to provide required functionality. The modules may be implemented in any suitable manner, but are typically implemented by executing appropriate applications software within a processing system 200, such as a server, or the like, as will be described in more detail below.

Examples of available modules include:
Action Management Module—responsible for the action management process described above by, for example:
   Receiving details of actions from other modules
   Assigning actions against corporate positions with automatic escalation of incomplete actions up the organizational hierarchy
   Generating email notifications of new and overdue actions
   Recurring Actions (the ability to generate actions on a recurring schedule from a template)
Organization Structure Module—module is responsible for maintaining the hierarchical organizational structure used by the action management module in performing alerting and escalation by, for example:
   Creating and maintaining the Organizational Tree with ability to assign:
      People.
      Security Roles.
      KPIs.
      Major Responsibility Areas.
      Mandatory/Desirable Qualifications.
SOX Reporting Module—responsible for generating the reports described above by, for example:
   Receiving requests for reports
   Querying action data stored in the SOX database
   Generating the requested reports
Contract Module—responsible for controlling the transfer of notifications to specific positions within the organizational structure by, for example:
   Determining an appropriate senior position for notification from the organizational structure
   Providing details of the appropriate senior position to the action management module
Incident Management Module—responsible for generating specific reports relating to incidents within the organization by, for example:
   Creating an action corresponding to requirements for completing an incident report, so that completion of the report can be monitored by the action management module
   This is used for Hazard/Incident Reporting, Investigation Reporting and Significant Potential Incident (SPI) Reporting or the like
   Reporting, both internal and for the DoIR
Document Management Module—responsible for consolidated management of documents within the organization by, for example:
   Storing and retrieving of electronic documents and files with full revision management
   Document Archiving (indexing of documents in archive boxes)
   Powerful Text and tree-based searching for electronic and archived documents
   Document Workflows
Document Control Module—responsible for consolidated management of document versions within the organization by, for example:
   Creating an action corresponding to the document version control actions for monitoring by the action management module
Training Module—responsible for ensuring completion of training by individuals within the organization by, for example:
   Defining a training schedule as an action for the action management module to allow alert generation if training is not completed in due time
   Qualifications tracking
Roster Module—responsible for monitoring work attendance/performance by individuals within the organization by, for example:
   Interfacing with timing and clocking systems to monitor an individuals working hours
   Providing details of an individuals working hours to the action management module to, for example:
      allow determination of whether actions in the training schedule are completed in due time
      allow an alert to be generated if working hour requirements are not met
   Provide working hour details to payment modules for controlling remuneration
   Monitor overtime, leave and sick leave hours
Risk Management Module—responsible risk management by, for example:
   Creating actions corresponding to the risk assessments that must be performed so that performance of the request can be monitored by the action management module
   Team-based Risk Assessment
   Job Safety Analysis (JSA)
Appointed Positions/Persons Module—responsible for monitoring the assignment of people to respective positions within the organizational structure defined by the organization structure module by, for example:
   Creating Positions Specifications (for both statutory and corporate appointments)
   Assigning of people to positions for defined periods
   Internal/External (DoIR) Letter generation
Personnel Module—responsible for maintaining information regarding future, potential, past and present personnel by, for example:
   Creating an action corresponding to the actions to be performed by an human resources department, such as hiring staff, so that performance of the hiring process can be monitored by the action management module
   storing details of Job Applicants/Applications, Employment Approval, Probationary Assessment, Personnel Details, Licenses, Clearances, Inductions, Disciplinary, Performance Appraisals, Exit Interviews, Training Record, Contact details/Next of Kin, Access Rights and Service Awards
Company Management Module—responsible for maintaining and policing company management information by, for example:
   Generating actions for delivery to the action management module, representing actions to be performed by management, such as maintaining Contact Details, Insurances and Site Clearance
Dynamic, Routable Questionnaires Module—responsible for ensuring completion of questionnaires by, for example:
   Generating actions representing questionnaire completion requirements for monitoring by the action management module.
   Maintaining questionnaires for inspections and audits
Security Module—responsible for ensuring security requirements are met by, for example:
   Maintaining User ID/Password with optional Windows Active Directory integration.
   Generating security actions for monitoring by the action management module (such as password update actions)
   Limiting Access restricted by “primitive functions”.
   Assigning primitive functions to roles.
   Assigning roles to corporate positions.
   Hierarchical Security (can only see info associated with lower positions)
Sarbanes-Oxley (SOX) Testing/Scheduling Module—responsible for use is testing SOX procedures by, for example generating test actions to be monitored, altered and escalated using the action management module.
Administration modules—responsible for handling administration requirements by, for example:
   Maintaining registers such as key registers, Media Register, Gifts & Gratuities Registers, Donations Register
   Generating actions for the actions management module for actions to be completed by administration
Access request modules—responsible for handling access requests for information by, for example:
   Determining an appropriate position within the organization, using the organization structure, to which a request may be sent
   Creating an action corresponding to the access request, so that performance of the request can be monitored by the action management module

A number of specific modules and their functionality will now be described in more detail below.

### Organization Structure Module

The organization structure, and in particular the hierarchical relationship between the different positions is defined using the organization structure module. In one example, the organization structure is defined as a “Position Tree” represents the hierarchical set of superior/subordinate line-management relationships between positions within the organization. This helps ensure the correct reporting of alerts from an Action Management, Security and Sarbanes-Oxley Auditing perspective.

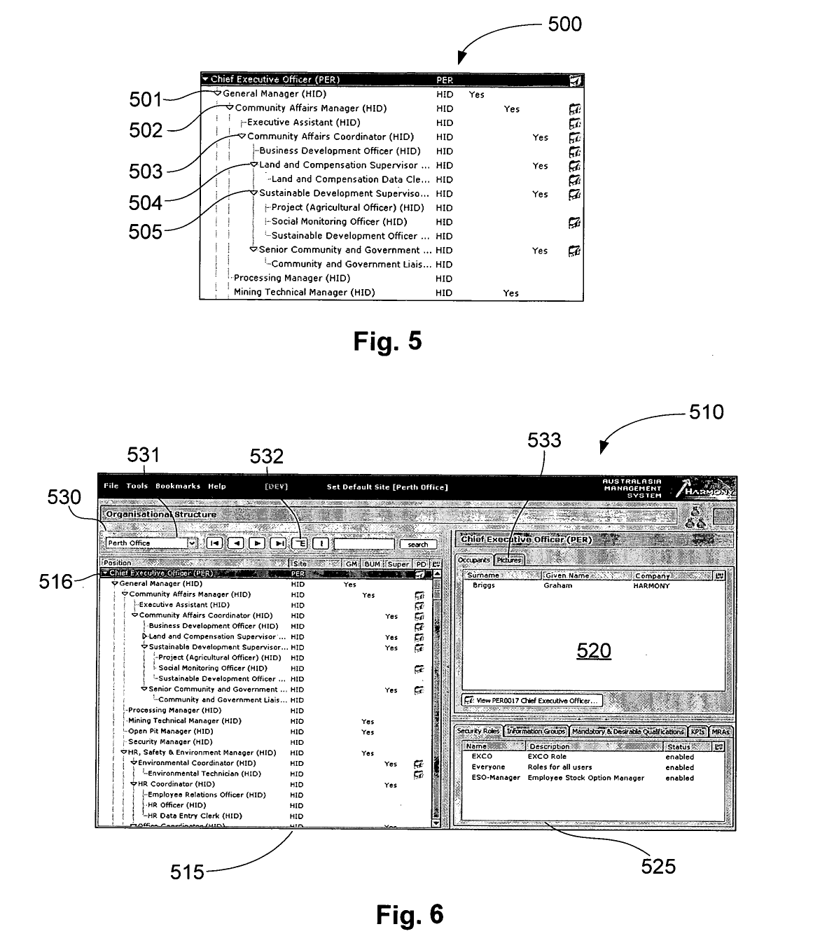

An example of the Position Tree is shown at 500 in FIG. 5. As shown, positions within the tree are represented by nodes shown generally at 501, 502, 503, 504, 505, with the relative position in the hierarchy being represented by parent child relationships. Thus, a general manager parent node 501, representing a general manager position, has a single community affairs manager node 502, representing a community affairs manager position. Thus, in this example, the community affairs manager is subordinate to the general manager.

Similarly the community affairs manager node 502 has a community affairs coordinator node 503, which in turn has a subordinate land and compensation supervisor node 504 and a sustainable development supervisor node 505. Further nodes are shown, but these will not be described in any further detail.

The Position Tree is generated by an administrative user who creates and maintains the Position Tree via user interface components or screens, generated by the processing system 200 using the Organization Structure module within the HAMS applications software. The Organization Structure module can be used to:
Add new positions (subsidiary to the selected position)
Delete selected position (along with any subsidiary positions)
Edit position details (including name, assigned site, etc)
Link a Position Description document to the position.
Move positions within tree structure
Copy positions from one part of the tree structure to another part of the tree.
View/add/remove actions from positions

Once created, the Position Tree can be viewed using a browser application on the user's end station 308.

An example of the screen generated by the organization tree module to view and manage the position tree is shown at 510 in FIG. 6. In this example, screen includes three panels, namely a tree panel 515, an occupant panel 520, and a roles panel 525. A number of controls are also shown at 530.

The tree panel 515 shows the position tree structure 500 described above. The user has the option to view and manipulate the tree to view positions of interest. When a respective position is selected, as shown at 516, the occupant panel 520 usually details of individuals occupying the selected position. Similarly the roles panel 525 shows roles associated with the position, such as Security Roles, Information Groups, Qualifications, Key Performance Indicators (KPIs) and Major Responsibility Areas (MRAs), for the particular person/position.

The user can select different regions of the position tree, such as the position tree associated with different offices, using the drop down list 531. The position tree can be manipulated using expand and collapse control buttons 532, 533.

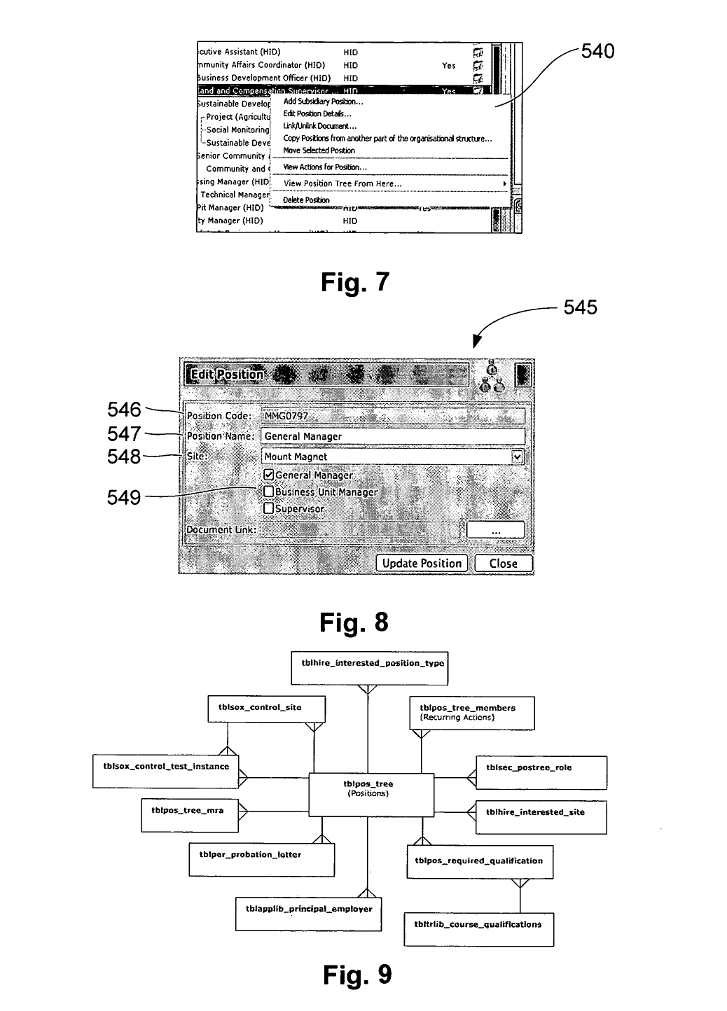

Additionally, a user may right click on the position tree 500, to display a menu 540 listing operations that can be performed on a certain position, as shown for example in FIG. 7. Example operations include editing the position details, adding subsidiary positions, linking or unlinking documents to the position, moving the position, and the like.

Selecting an ‘Edit Position Details’ menu option from the menu 540 allows a dialog box 545 to be displayed, as shown in FIG. 8, which allows details of the respective position to be altered. For example, this allows the alteration of a position code, position name, an associated site to be entered. Additionally a position type is selected using the check boxes 549, defining the relative positioning of the position within the hierarchy.

It will be appreciated that user's with appropriate access rights can add/move persons to/from a position displayed in the position tree 500, by editing details displayed in the occupant and roles panels 520, 525. Thus, for example, a user can drag and drop details of an individual within the company from another screen (not shown), or from another position within the organization, thereby adding the individual to the currently displayed position 516.

Clicking on the pictures sub-tab 521 displays any pictures of the occupants that are on the occupants' personnel records. Additionally, selection of the occupants name allows additional details of the occupant to be displayed such as a CV, or the like.

A printable version of the Organizational Structure can also be accessed by choosing the topmost position that you wish to include on the diagram and selecting “View Position Tree from here . . . ”. It is possible to view 1, 2, 3, 4, 5, or all levels below the selected position.

The position tree is maintained as position tree data stored in a position tree database. The position data defines the different positions within the organization, together with the relationships therebetween, thereby allowing the position tree to be defined. The position tree module interacts with the position tree data by generating, storing and accessing the position tree data, to allow the organizational structure to be defined and provided to other modules, such as the action management module, and used as required.

The position tree data also includes details, such as links to:
individuals occupying positions within the organization
roles associated with respective positions; and,
actions associated with the positions.

Details of the position tree data and in particular examples of the tables used in the position tree database are shown in APPENDIX A. In particular, the tblpos_tree_members provides the link between positions in tblpos_tree.id and persons in tblper_personaldetails.id (see APPENDIX A). This structure allows the easy management of positions within HAMS.

A Position Description document can (optionally) be linked to each individual position. All documents are stored in the table tbladoc_document (see APPENDIX A). These documents generally identify and describe the main points of that position. Eg: Primary Objective, Job Profile, Job Requirements and Key Performance Indicators.

Actions can also be assigned to positions. These actions are then relevant to all of the people occupying that position. The Actions Module is used throughout HAMS with every link to an action being recorded in the table tbllink_entity_link (see APPENDIX A).

A basic Entity Relationship Diagram for the Organizational Structure is shown in FIG. 9. The tables in APPENDIX A describe a particular implementation of the various components of the tree.

### Actions

In the above examples, an action is simply a task that must be completed by (the person filling) a specific position within the organizational structure, by a specific date, which forms the management criteria. Actions can be created, edited and deleted from within the Actions Module. An Action can either be ‘completed’, ‘not yet due’, ‘overdue’ or ‘deleted’.

A Recurring (Scheduled) Action is a template from which Actions can be automatically generated at a specified time interval. For example, a recurring action could be used to generate an action requiring a safety officer to check fire extinguishers on a monthly basis. Recurring actions can loop for a given amount of time, a given number of repetitions, infinitely or until a generated action has been completed.

A notification email is sent to the position required to complete the action on creation and the day the action is due (if not already completed). If an action becomes overdue an email is then escalated up the organizational structure. Emails will continue to be sent up the chain of command every 7 days until the action has been completed by the relevant position.

The following examples describe various scenarios in which an action is escalated. In these examples, Person one is the person who Created Action and Person two is the person to which the action is assigned.

As described above, by assigning actions (tasks that need to be completed by a specific date) to positions as opposed to individuals, this has the advantage that actions do not get ‘lost’ or need re-assignment when the occupant of a position changes. However, it should be noted that an individual (not a position) completes an action.

If an action is not completed by its assigned position by the specified schedule, then the action is escalated to the superior position. If that superior position has no occupants, then the action continues to escalate until it reaches one that does. The occupants of the action target position and the superior position are emailed to notify them of the delayed completion. This process continues on a configurable basis until the action is completed or until it has escalated to the top position in the hierarchy.

### Reporting

The reporting module can be used to allow a user with appropriate access rights can view the actions and completion statistics for a position by selecting a “View Actions for position . . . ” from the menu 540, shown in FIG. 7.

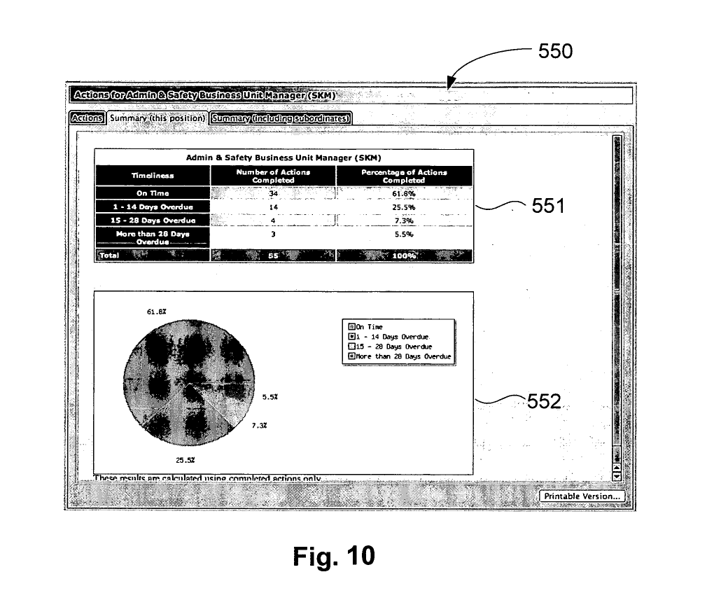

An example of a screen 550 used to display details of actions associated with a position is shown in FIG. 10. In particular, this includes a table 551 showing a summary of actions associated with the position, together with details of their completion, with a corresponding graphical representation being shown at 552.

In this instance, the report module accesses action data corresponding to the actions performed by the currently selected position, and then arranges to populate a template corresponding to the table and the graphical representation with the appropriate action data, allowing the information to be displayed.

### Escalation

As described above, every individual within an organization is assigned to a position within the organizational structure. Being assigned to a position allows HAMS users to have security roles, actions, MRAs, KPIs (etc) assigned to them. It also allows email notifications to be sent to their position regarding approvals, complaints etc. The HAMS organizational structure provides a centralised place where data can be added/updated or deleted and automatically inherited by all persons occupying a position. Every HAMS user account requires it be assigned to a position before it becomes active and can be used.

### EXAMPLE 1

1) Action created by person one
2) Assigned to person two
3) Email sent to person one notifying them of the action.
4) Email sent to person two on the day that the action is due.
5) 7 Days overdue—action is sent to person two's manager.
6) Every 7 days an email is sent up the chain of command until the action has been completed by the relevant position.

### EXAMPLE 2

### The Action is Completed Before Escalation

1) Action Assigned to Administrator & HR Coordinator (CAI)
2) Email is sent to Administrator & HR Coordinator (CAI) notifying them of the action
3) Action completed.

### EXAMPLE 3

### The Action is Completed Before Escalation

1) Action Assigned to IT and Database Manager Perth
2) Email is sent to IT and Database Manager Perth notifying them of the action
3) Email sent to IT and Database Manager Perth 2 days before action is due reminding them that action is due.
4) Action completed

### EXAMPLE 4

1) Action Assigned to Application Developer
2) Email is sent to Application Developer notifying them of the action
3) Email sent to Application Developer days before action is due reminding them that action is due.
4) [7 days later—Action not completed]—Email sent to IT and Database Manager Perth
5) [7 days later—Action still not completed]—Email sent to Chief Financial Officer
6) Action was completed

### EXAMPLE 5

1) Action Assigned to Maintenance Planner—Jubilee (SKM)
2) Email is sent to Maintenance Planner—Jubilee (SKM) notifying them of the action
3) Email sent to Maintenance Planner—Jubilee (SKM) days before action is due reminding them that action is due.
4) [7 days later—Action not completed]—Email sent to Maintenance Coordinator—Jubilee (SKM)
5) [7 days later—Action still not completed]—Email sent to Jubilee Business Unit Manager
6) [7 days later—Action still not completed]—Email sent to General Manager (SKM)
7) Action was completed

### Contracts

An FM073 Contracts Module uses the HAMS Organizational structure to control the transfer of notifications to senior positions within the organizational structure. These notifications ensure that persons occupying these positions are aware of new employment offers and variations and can approve them.

In the following examples, Person one is the person who created FM073 and Person two is the Person who FM073 is created against.

### EXAMPLE 1

1) FM073 Created by person one
2) HAMS moves up the organizational structure to find the first Business Unit Manager above person two's position.
   An email is sent to this position notifying them that their approval is required.
   If a Business Unit Manager does not exist, HAMS moves onto step 2.
3) HAMS moves up the organizational structure to find the first General Manager above the Business Unit Manager above (if exists) otherwise it finds the first General Manager above person two's position.
   An email is sent to this position notifying them that their approval is required.
   If a General Manager does not exist, HAMS moves onto step 3.
4) Email notification is sent to the appropriate EXCO member in the organizational structure, notifying them that their approval is required.
5) An action is assigned to the relevant HR position above person one to create a printable contract for this FM073.

### EXAMPLE 2

1) FM073 Created by HR & Admin Administrator (SKM)
2) Email is sent to Business Unit Manager—Admin & Safety Business Unit Manager (SKM) notifying them that their approval is required.
3) Email sent to General Manager—General Manager (SKM) notifying them that their approval is required.
4) Email is sent to EXCO—Operations Manager (PER) notifying them that their approval is required.
5) Action is assigned to HR & Admin Administrator (the creator) notifying them that FM073 has been approved and to create a printable contract.

### EXAMPLE 3

1) FM073 Created by HR & Safety Administrator (MMG)
2) Email is sent to Business Unit Manager—Admin, HR & Safety Manager (MMG) notifying them that their approval is required.
3) Email sent to General Manager—General Manager (MMG) notifying them that their approval is required.
4) Email is sent to EXCO—Operations Manager (PER) notifying them that their approval is required.
5) Action is assigned to HR & Safety Administrator (the creator) notifying them that FM073 has been approved and to create a printable contract.

### EXAMPLE 4

1) FM073 Created by Application Developer (PER)
2) Email is sent to Business Unit Manager—IT and Database Manager (PER) notifying them that their approval is required.
3) No General Manager exists above this position—No Email is sent.
4) Email is sent to EXCO—Group Admin, HR & Safety Manager (PER) notifying them that their approval is required.
5) Action is assigned to Systems & HR Administrator (Pre-defined HR position to use if no HR position exists) notifying them that FM073 has been approved and to create a printable contract.

### Access Requests

The Access Requests Module uses the HAMS Organizational structure to send notifications up the chain of command to the appropriate positions. These notifications ensure that the required positions are aware that their approval is required and that specific access requests need implementing. At current HAMS, Computer and Pronto access requests are using this system.

In the following example, Person one is the person who submitted access request, where the access regards Person two, Person three is the person required to approve the access request, and Person four is the person required to implement the access request.

### EXAMPLE 1

1) HAMS access request is submitted by person one
2) HAMS moves up the organizational structure to find the first Business Unit Manager above person two's position. An email is sent to this position notifying them that their approval is required.—Moves to step 4
   If a Business Unit Manager does not exist, HAMS moves onto step 3.
3) HAMS moves up the organizational structure to find the first General Manager above person two's position. An email is sent to this position notifying them that their approval is required. If a General Manager does not exist, HAMS Emails a pre-defined position.
4) If access request is approved an email is sent to the pre-defined position that is required to implement the access changes.
5) If access request was declined no other actions is taken.

### EXAMPLE 2

1) HAMS access request is submitted by Admin & Safety Business Unit Manager for position Electrical Supervisor—Jubilee.
2) Email is sent to Jubilee Business Unit Manager notifying them that their approval is required. Since a Business Unit Manager has been found HAMS does not need to find a General Manager.
3) Access Request was approved by Jubilee Business Unit Manager therefore an email is sent to Application Developer to Implement Access.

### EXAMPLE 3

1) Computer access request is submitted by Systems & HR Administrator for position Financial Accountant (PER).
2) HAMS does not find a Business Unit Manager above the position—Financial Accountant (PER).
3) HAMS finds a General Manager above the position Financial Accountant (PER) and sends an email to General Manager (HID) notifying them that their approval is required.
4) Access Request was approved by General Manager (HID) therefore an email is sent to Application Developer to Implement Access.

### SPI (Significant Potential Incident) Reporting

When a user creates a new incident within HAMS they have the option of creating an SPI within the incident reporting module. If an SPI is created and it is approved by a general manager, it sets off a trigger that sends email notifications to all supervisors and above. These emails are only sent out when an initial or final SPI for an incident has been created and approved by a general manager. If the general manager does not approve the SPI, HAMS does not sent out emails to supervisors.

Thus, in this instance, the incident reporting module creates an action corresponding to the occurrence of an SPI, to allow the automatic generation of e-mails, when it is determined that an initial or final SPI for an incident has been created and approved.

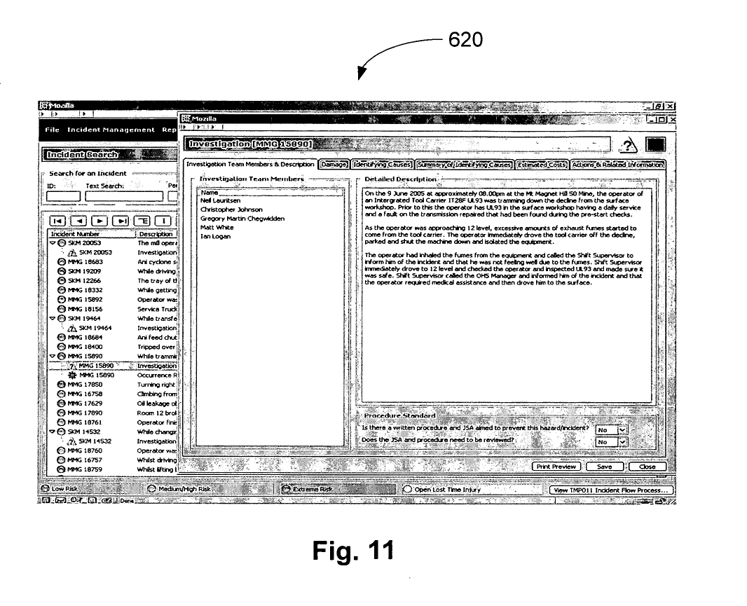

Once reports have been created, these can then be subsequently viewed, for example, an incident search/investigation 620 screen similar to that shown in FIG. 11.

In the following example, Person one is the person who created the incident.

### EXAMPLE 1

1) HAMS incident created by person one.
2) Person one decides that an SPI should be created.
3) General manager approves SPI.
4) HAMS searches through the organizational structure and find all supervisors and positions above them. It emails out an SPI report to all these positions notifying them that an initial SPI for the incident has been created.
5) Final SPI is created.
6) General manager approves SPI.
7) HAMS searches through the organizational structure and find all supervisors and positions above them. It emails out an SPI report to all these positions notifying them that a final SPI for the incident has been created.

### EXAMPLE 2

1) HAMS Incident is created by Systems & HR Administrator.
2) Initial SPI is created.
3) SPI is approved by Group Safety & Training Coordinator.
4) Email notification is sent out to all supervisors within the HAMS organizational structure regarding the initial SPI report.
5) Final SPI is created.
6) SPI is approved by Group Safety & Training Coordinator.
7) Email notification is sent out to all supervisors within the HAMS organizational structure regarding the final SPI report.

### Security and Permissions

Security permissions handled by the security module can use the organizational structure. Security settings can be assigned to positions in the organizational structure rather than individual persons. This allows all persons occupying a position to inherit all of the same permissions. HAMS was developed this way so that persons could easily change positions within the HAMS organizational structure yet still have predefined security roles for the position they are assigned to. It allows efficient updating of data and far better control over security access from within HAMS.

MRAs (Major Responsibility Areas & KPIs (Key Performance Indicators)) can be assigned to positions within HAMS, rather than persons. This allows better organization and faster updates when people are moved around HAMS organizational structure. Much like permissions, persons occupying a position automatically inherit all of the MRAs and KPIs for that position.

BUMs (Business Unit Managers) & GMs (General Managers) can be assigned to positions within the organizational structure, not just an individual position. This prevents the issue of a person moving positions within the organizational structure and still having BUM or GM roles attached to them, when they may not be still applicable. Security risks would eventuate if this occurred as BUM and GM positions have extended access to features in HAMS such as approvals, employment details, personnel details etc.

### Training

A training module in HAMS allows users to create and sit courses/qualifications online. The authoring section of the training module uses the organizational structure to determine which positions need to review courses waiting to be published. Pre-defined positions are selected from the organizational structure and stored in a training database.

The selected positions are then responsible for reviewing and approving courses developed through HAMS. Assigning a position as a reviewer rather than an individual person, resolves the problem of courses not being reviewed due to the fact that a person was out of the office. When a person is away, someone else automatically fills that position, resulting in them receiving notifications that courses need to be reviewed. If multiple people occupy the same position they will all receive notifications, however, only one person is required to review the course.

Additionally, the training module can be used to monitor for completion of training, such as induction courses, or other training, by occupants of positions within the organization. In this instance, a training schedule is associated with a position, with an action corresponding to the training schedule being defined and provided to the action management module. The action will typically include tasks corresponding to the completion of certain training milestones. In this instance, the management criteria define certain time limits for the completion of the training milestones.

By interfacing with a roster module, the action management module can determine the length of time an occupant of a position has been working, allowing the action management module to compare the amount of completed training to the defined management criteria. In the event that training milestones are not timely completed this allows a suitable alert to be generated and transferred to a supervisor, thereby ensuring training is completed.

### Software Architecture

An example of a specific example of the software components utilised within HAMS will now be described.

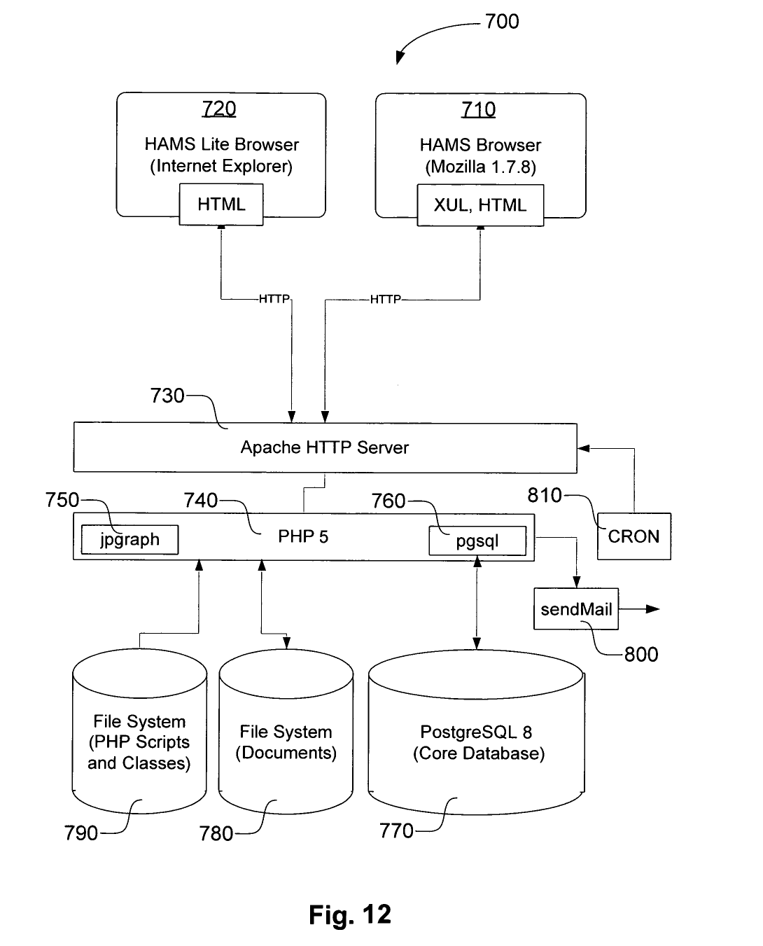

In particular, the application is typically built as three logical tiers; these being: Presentation (HTML and XUL rendered in the Mozilla/Firefox/Netscape Browser), Application (PHP code to access the database and generate XUL and HTML for display via the browser), and Data (PostgreSQL RDBMS accessed via SQL and including a degree of business/reporting logic implemented as stored procedures). FIG. 12 shows an example Application Architecture 700.

### Presentation Layer

The presentation layer of the application is the part with which the end-user interacts. The application is web-based, primarily using XUL (rendered via Mozilla or Firefox) rather than HTML. The UI is significantly richer than can be achieved using plain HTML. The additional functionality (such as tab folders, re-orderable lists, popup windows and menus) has been achieved through a combination of XUL, JavaScript and Cascading Style Sheets (CSS).

To circumvent some of the limitations typically encountered in web-based applications, there are two interoperable versions of HAMS.

Full HAMS (Mozilla/Mozilla Firefox) 710 is developed using eXtensible User Interface Language (XUL). XUL is only available in the Netscape, Mozilla and Firefox browsers, but it provides much richer, more ‘windows-like’ functionality than can be created using plain HTML. The only disadvantage of Mozilla (versus Internet Explorer) is that it does not come pre-installed on Windows. However, it is free and can be simply distributed onto all Windows PCs on the network via Active Directory and MSI. Unlike Internet Explorer, Mozilla and Firefox (and therefore HAMS) also run on a variety of non-windows platforms, such as Macintosh OS X.

HAMSLite (MS Internet Explorer), 720 on the other hand, provides a limited-functionality version of HAMS which runs in Microsoft Internet Explorer. HAMSLite is primarily aimed at users that require read-only access to documents, information and reports stored in HAMS, but do not require the ability to update information. There are typically a greater number of HAMSLite users than HAMS users. HAMSLite is also available embedded within Full HAMS and runs under Mozilla/Firefox.

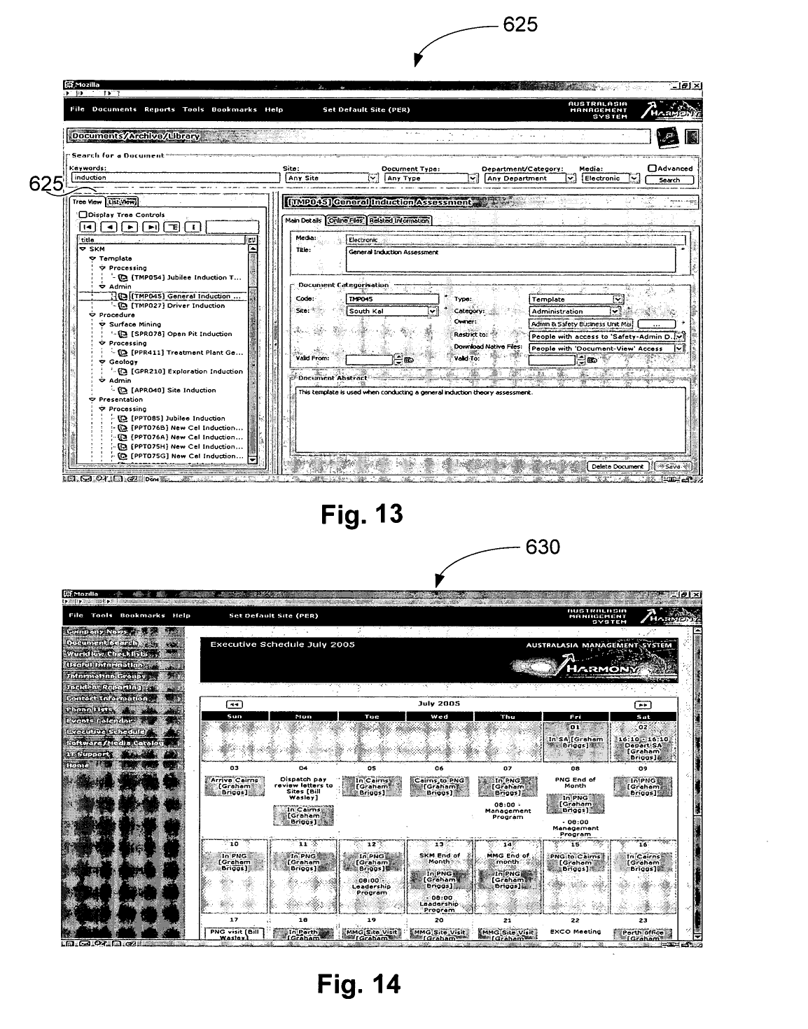

Example HAMS screen shots, showing various user interfaces are shown in FIGS. 6, 10, and 11 described above. Additional examples are shown in FIGS. 12 and 13, which show respectively an interface 625 presented by the document management module to allow document search and retrieval, and an example interface 630 for displaying an example executive calendar implemented by the Administration Module.

### Application Layer

The application server layer is formed from an Apache Web Server 730, a PHP (Hypertext Pre-Processor) 5 scripting language module 740, and JPgraph 750.

PHP5 is a widely-used general-purpose scripting language that is especially suited for Web development and can be embedded into HTML. PHP is in many ways analogous to the JavaServer Pages (JSP) technology on the J2EE platform.

This is a commercially licensed, PHP library for generating bar charts, pie charts, Gantt charts and so on. A number of the Action Management and Incident Management reports include graphs rendered using JPGraph.

### Data Layer

The data layer typically includes a PostgreSQL (Structured Query Language) 760, which is a fully-featured Relational Database Management System (RDBMS) 770, and FreeBSD v4.7, which acts as a server platform.

Documents and scripts may also be stored in respective databases 780, 790, as shown

The majority of information manipulated by the application is stored in a PostgreSQL instance running on the FreeBSD server. However, digital copies of documents (such as PDFs, word documents, photographs, and so on) are stored directly on the server file system with only the associated meta-data actually stored in PostgreSQL. Although data from the RDBMS is always accessed from the central server, documents are accessed from the users' nearest site server (thus massively reducing traffic across the WAN). Changed and new documents are synchronised between site servers overnight when the WAN bandwidth is at its lowest utilisation.

### Reporting

Reports are typically provided in HTML format. The user enters reporting criteria into custom query pages and the reports are generated and displayed in real time. The reports are all generated by PHP scripts.

### Scheduling

A UNIX CRON service 810 is used for task scheduling. For instance, an hourly job determines whether any action notification emails need sending out, as shown at 800. The job is written in PHP but is executed by CRON. CRON is also used to schedule the overnight synchronisation of documents and source-code between servers.

### Deployment Architecture

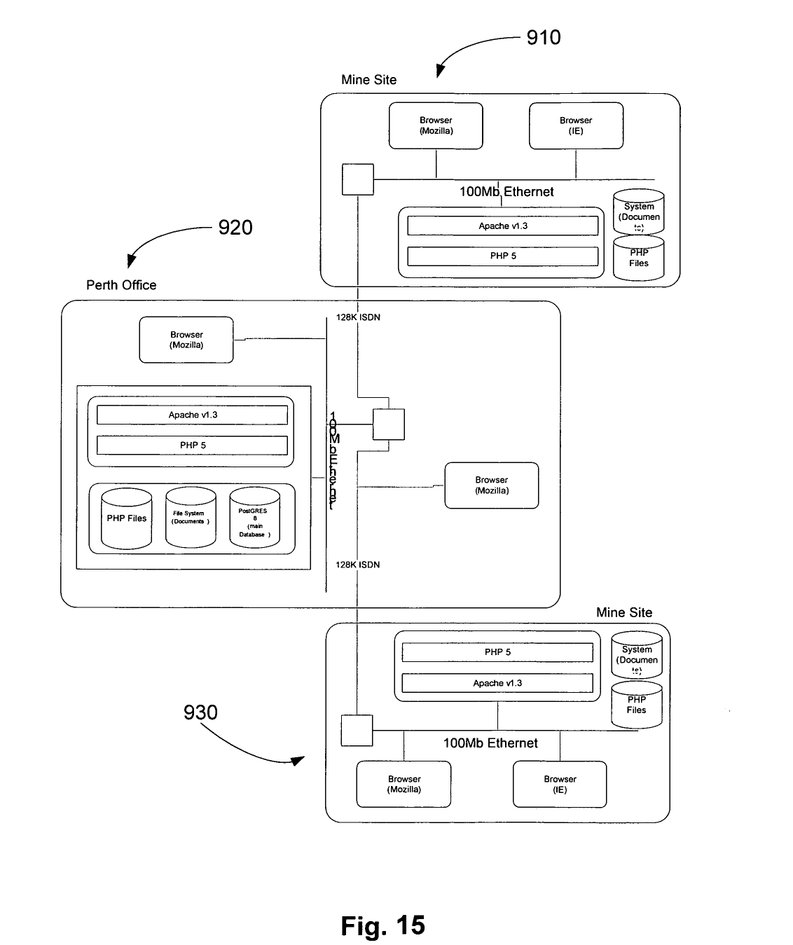

FIG. 15 shows how the HAMS application is deployed. The Perth Office 920 hosts a central Database Server. This server also runs an application server which provides the application to the Perth Office. Each of the mine sites 910, 930 using HAMS (there are currently two such sites) also has a local replica of the Application Server, but not the database server.

The reason for distributing the application in this way is that the SQL database traffic is much lighter than HTML/XUL traffic. Because the links to the mine sites are already utilised heavily by other applications such as Pronto and email, performance is significantly impaired if this distributed architecture is not employed. RSYNC is used to distribute code changes and new documents to the mine site servers.

### Security

The application enforces comprehensive hierarchical and position/role-based access to data. A description of the security model is outside the scope of this document.

The network infrastructure does not include any firewalls or other security specific infrastructure. This is because it is deployed internally on a secure network. Should any components of the application be deployed onto a public network such as the Internet or onto a partner network (such as a contractor's extranet), then appropriate firewall infrastructure would need to be provided.

Backups (PostGreSQL, XUL Source and Documentation Repository)

The PostgreSQL, Source Code and Documents can be backed up periodically, such as nightly. Several backups are typically maintained, with the oldest being deleted each night in order to provide sufficient space for the newest.

As well as being stored on tape at head-office, the compressed backup archive file is also replicated to each of the site servers to ensure that an offsite backup is available in the case of a catastrophic failure occurring with regards to the head office IT systems.

Availability, Redundancy and Failover

A degree of redundancy exists by virtue of each site having its own Application Server running Apache and PHP. The loss of one of these servers will affect only a single site, whilst other sites will continue to function normally (assuming that the PostgreSQL server is still operational). Should HA be determined to be a requirement in the future, the Application Servers could be clustered with minimum of effort (using a reverse-proxy such as SQUID or an IP spraying product like IBM's Network Dispatcher).

Note that there is no failover or redundancy within a given site of within the central PostgreSQL database. Failure of PostgreSQL (or the network on which the central machine is mounted) will render the application unavailable to all users. To mitigate against this eventuality, the HAMS development server can be re-tasked to be the production server in a matter of minutes. Human intervention is required in order to reload the development server from the previous night's backup of the production database.

Thus, there has been provided a method and system for action management.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

### Appendix A

TABLE 1
Basic Table

| Table | Description |
|---|---|
| tblpos_tree | Lists all of the enabled/disabled positions within HAMS. |
| tblpos_tree_members | Link between the position tree (tblpos_tree.id) and |
| | persons occupying these positions |
| | (tblper_personaldetails.id). |
| tblpos_tree_mra | Lists the major Responsibilities areas of positions. |
| tblpos_required_qualification | Link between positions (tblpos_tree.id) and qualifications |
| | (tbltrlib_course_qualifications.id). |
| tblsec_postree_role | Link between HAMS users (tblper_persondetails.id) and |
| | positions (tblpos_tree.id). |

TABLE 2
Views

| | Base Tables & | |
|---|---|---|
| View | Underlying Views | Purpose |
| v_positions_with_depth | tblpos_tree | Lists positions |
| | f_get_position_depth | with depth. |

Triggers are used for various purposes, particularly maintaining the synchronisation of tables that are related to different modules.

TABLE 3
PL/PGSQL Trigger Functions

| Table | Trigger_function | Condition | Purpose |
|---|---|---|---|
| tblpos_tree | set_postree_position_code_trigger | BEFORE | This function |
| | | INSERT OR | generates a |
| | | UPDATE | unique Position |
| | | | ID. |
| tblpos_tree | tblpos_tree_ins | BEFORE | Sets modified |
| | | INSERT | timestamp. |
| tblpos_tree | tblpos_tree_upd | BEFORE | Sets modified |
| | | UPDATE | timestamp. |
| tblpos_tree | tblpos_tree_upd_del | BEFORE | Sets the Delete |
| | | UPDATE | Time in the |
| | | | Position Tree. |
| | | | Also prevents |
| | | | deletion of |
| | | | positions if there |
| | | | are still important |
| | | | entities |
| | | | referencing the |
| | | | position. |
| tblpos_tree_members | check_pos_tree_member_duplicates | BEFORE | This function |
| | | INSERT | ensures a person |
| | | | cannot be |
| | | | assigned to the |
| | | | same position in |
| | | | the organizational |
| | | | structure more |
| | | | than once at any |
| | | | given time. |
| tblpos_tree_members | tblpos_tree_member_upd_del | BEFORE | Determines if new |
| | | UPDATE | del_flag has been |
| | | | set to true. If it |
| | | | has column |
| | | | valid_to is set to |
| | | | current |
| | | | timestamp. |
| tblpos_tree_members | tblpos_tree_members_ins | BEFORE | Sets modified |
| | | INSERT | timestamp. |
| tblpos_tree_members | tblpos_tree_members_upd | BEFORE | Sets modified |
| | | UPDATE | timestamp. |

TABLE 4
PL/PGSQL Functions

| Function | Arguments | Purpose |
|---|---|---|
| f_get_position_depth | _person_id_functions_function_list | Returns functions list for |
| | | a given position. |
| f_get_people_for_position(int4) | _position_id_people | Returns the list of people |
| | varchar | that occupy a corporate |
| | | position |
| f_get_sec_role_list(int4) | _person_functions_function_list | Returns a list of roles for |
| | | a given person_id |

TABLE 5
Files and Functions

| Screen | Implemented by | Notes |
|---|---|---|
| Organization | /positions/posTree.php | Main screen for |
| Structure | /positions/position_description_doc | Organizational Structure in |
| | link.php | HAMS. |
| | /gqr/blank.xul | Displays: |
| | /positions/security_roles_include.php | Positions within HAMS |
| | /positions/info_groups_include.php | Persons occupying |
| | /positions/qualifications_include.php | positions |
| | /positions/kpi_include.php | Security Roles of position |
| | /positions/mra_include.php | Information Groups |
| | | Qualifications |
| | | KPIs |
| | | MRAs |
| Shared JavaScript | /position/positionOverlay.js | |
| Menu | /overlays/menubar.php | |

### Files and Basic Implementation Details

### Organization Structure

displayTree.php
This is a container for displaying an image of the Positions Tree.
info_groups_include.php
Information Groups associated with a Corporate Position.
mra_include.php
Major Responsibility Areas associated with a Corporate Position.
position_pictures.php
Generates a panel of mugshots for each of the people that occupy a position in the organizational structure.
positionActions.xul
This tab allows the user to view/modify the positions (e.g. General Manager, Safety Director) that are assigned to the user.
positionCopy.xul
This form is used to capture the additional constructs that the user wishes to copy when copying a set of positions.
positionCopy.xul
This form is used to capture the additional constructs that the user wishes to copy when copying a set of positions.
positionDetails.xul
positionEdit.xul
This form allows the user to edit the name of a Position Tree entry.
positionMove.xul
This form is used to capture the destination in the position tree when the user wants to move a position (and any positions that are under it).
positionsManager.xul
posTree.php
Allows the user to create, view and modify position details.
qualifications_include.php
Qualifications assoociated with a Corporate Position.
security_roles_include.php
Security Roles assoociated with a Corporate Position.

### RDF

kpiRDF.php
This file generates an XML RDF file, representing the Key Performance Indicators associated with a Position.
mraRDF.php
This file generates an XML RDF file, representing the Major Responsibility Areas associated with a position.
mraRDF.php
This file generates an XML RDF file, representing the Major Responsibility Areas associated with a position.
posMembersRDF.php
postionsRDF.php
Generates the RDF File for the Position Tree.

### Other

occupantPopup.xul
position_description_doclink.php
positionsOverlay.js
upload.php
Handles request processing from the HAMS UI Position Tree Module to the Server.

What is claimed:

1) A method of managing an action within an organization, the organization including at least two positions, each position having one or more occupants, each occupant being an individual for performing an action, the method including, in a processing system:
a) for an action associated with a first position, comparing an action status to management criteria; and,
b) alerting a second position depending on a result of the comparison.

2) A method according to claim 1, wherein the positions within the organization are arranged in a hierarchy with the second position being more senior than the first position.

3) A method according to claim 1, wherein the method includes, in the processing system:
a) for a selected position more senior than the first position, determining if the selected position is occupied; and,
b) determining the selected position to be the second position if the selected position is occupied.

4) A method according to claim 1, wherein the method includes, in the processing system, escalating the action to the second position such that the action can be performed by an occupant of the second position.

5) A method according to claim 4, wherein the method includes, in the processing system, escalating the action by adding the action to an action indication associated with the second position.

6) A method according to claim 4, wherein the method includes, in the processing system, repeatedly escalating the action through the organization until a predetermined action status is reached.

7) A method according to claim 1, wherein the method includes, in the processing system, comparing the action status to the management criteria to determine if the action is at least one of:
a) started;
b) partially completed; and,
c) completed.

8) A method according to claim 1, wherein each action is formed from a sequence of one or more tasks, and wherein the method includes, in the processing system, determining an action status by monitoring for the completion of the one or more tasks associated with the action.

9) A method according to claim 8, wherein the method includes, in the processing system, comparing the action status to the management criteria by:
a) determining at least one time frame from the at least one management criterion, the at least one time frame being indicative of a time for completion of a corresponding task; and,
b) determining if the corresponding task is completed within the at least one time frame.

10) A method according to claim 1, wherein the method includes, in the processing system, communicating the alert by at least one of:
a) email; and,
b) a message on a management console.

11) A method according to claim 1, wherein the method includes, in the processing system, storing action data indicative of performed actions.

12) A method according to claim 11, wherein the action data is indicative of at least one of:
a) positions to which actions have been assigned;
b) positions to which actions have been escalated;
c) an indication of monitored action status and whether action milestones are met; and,
d) details of any generated alerts.

13) A method according to claim 11, wherein the method includes, in the processing system, implementing a reporting module, the reporting module being for:
a) retrieving action data; and,
b) generating a report based on the action data.

14) A method according to claim 1, wherein the method includes, in the processing system, implementing an action management module, the action management module being for:
a) comparing the action status to the management criteria; and,
b) generating an alert depending on a result of the comparison.

15) A method according to claim 14, wherein the action management module is for:
a) receiving at least one action from at least one other module; and,
b) managing the at least one action.

16) A method according to claim 1, wherein the method includes, in the processing system, interacting with position tree data representing a position tree indicative of the structure of positions within the organization, the interaction including at least one of generating, storing, and accessing the position tree data.

17) A method according to claim 16, wherein the position tree data is indicative of:
a) positions within the organization; and,
b) relationships between the positions.

18) A method according to claim 16, wherein the position tree data is indicative of:
a) individuals occupying positions within the organization
b) roles associated with respective positions; and,
c) actions associated with the positions.

19) A method according to claim 16, wherein the processing system implements a position tree module for:
a) interacting with the position tree data; and
b) providing details of the position tree to one or more other modules.

20) An apparatus for managing an action within an organization, the organization including at least two positions, each position having one or more occupants, each occupant being an individual for performing an action, the apparatus including a processing system for:
a) for an action associated with a first position comparing an action status to management criteria;
b) alerting a second position depending on a result of the comparison.

21) An apparatus according to claim 20, wherein the apparatus is configured to perform the method of claim 1.

22) A computer program product for managing an action within an organization, the computer program product including computer executable code which when implemented by a suitable processing system causes the processing system to:
a) for an action associated with a first position compare an action status to management criteria;
b) alert a second position depending on a result of the comparison.

23) A computer program product according to claim 22, wherein the computer program product is configured to perform the method of claim 1.

24) A computer implemented method for action management within an organizational structure comprising:
creating a position definition;
associating one or more occupants to the position;
linking the position definition to a parent position definition;
assigning an action to the position definition; and
defining action execution parameters for the action
wherein, if the action satisfies a predetermined criterion based on one or more execution parameters then, one or more occupants of an ancestor position are alerted.

25) A computer implemented method for action management according to claim 24, wherein one or more occupants of the parent position are alerted.

26) A computer implemented method for action management according to claim 24, wherein if the parent position does not have at least one occupant, one or more occupants of a grandparent position superior the parent position are alerted.

27) A computer implemented method for action management according to claim 24, wherein each ancestor position of the position are recursively examined until an occupied ancestor position is located that has at least one occupant and the one or more occupants of the occupied ancestor position are alerted.

28) A computer implemented method for action management according to claim 24, wherein the alert is communicated in the form of an email.

29) A computer implemented method for action management according to claim 24, wherein the alert is communicated in the form of a message on a management console.

30) A computer implemented method for action management according to claim 24, wherein the execution parameters include a due date for completion of the action.

31) A computer implemented method for action management according to claim 30, wherein the predetermined criterion is that the date for completion has passed without completion of the action.

32) A computer implemented method for action management according to claim 24, wherein the execution parameters include a date for starting the action and the predetermined criterion is that the date for starting the action has passed without the action being started.

33) A computer implemented method for action management according to claim 24, wherein the execution parameters include a percent complete milestone date for having a fixed percentage of the action complete and a percentage complete parameter to indicate the percentage of the action complete and the predetermined criterion is the date for starting the action has passed and that the has-started flag indicates that the action has not yet been started.
